(19) United States
(12) Patent Application Publication
(10) Pub. No.: US 2022/0229432 A1
(43) Pub. Date: Jul. 21, 2022

(54) AUTONOMOUS VEHICLE CAMERA INTERFACE FOR WIRELESS TETHERING

(71) Applicant: Ford Global Technologies, LLC, Dearborn, MI (US)

(72) Inventors: John Robert Van Wiemeersch, Novi, MI (US); Erick Michael Lavoie, Van Buren Charter Township, MI (US)

(73) Assignee: Ford Global Technologies, LLC, Dearborn, MI (US)

(21) Appl. No.: 17/154,954

(22) Filed: Jan. 21, 2021

(51) Int. Cl. G05D 1/00; H04N 7/18; H04W 76/10; H04W 4/40

(52) U.S. Cl. CPC G05D 1/0033; H04N 7/185; H04W 4/80; H04W 4/40; G05D 1/0022; H04W 76/10

(57) ABSTRACT

A method for controlling a vehicle using a mobile device includes receiving, via a user interface of the mobile device, a user input selection of a visual representation of the vehicle. The method further includes establishing a wireless connection with the vehicle for tethering with the vehicle based on the user input, determining that the mobile device is within a threshold distance limit from the vehicle, performing a line of sight verification indicative that the user is viewing an image of the vehicle via the mobile device, and causing the vehicle, via the wireless connection, to perform a remote vehicle movement control action while the mobile device is less than the threshold tethering distance from the vehicle.

### TECHNICAL FIELD

The present disclosure relates to autonomous vehicle interfaces, and more particularly, to a camera interface for remote wireless tethering with an autonomous vehicle.

### BACKGROUND

Some remote Autonomous Vehicle (AV) level two (L2) features, such as Remote Driver Assist Technology (ReDAT), are required to have the remote device tethered to the vehicle such that vehicle motion is only possible when the remote device is within a particular distance from the vehicle. In some international regions, the requirement is less than or equal to 6 m. Due to limited localization accuracy with existing wireless technology in most mobile devices used today, the conventional applications require a user to carry a key-fob which can be localized with sufficient accuracy to maintain this 6 m tether boundary function. Future mobile devices may allow use of a smartphone or other connected user devices when improved localization technologies are more commonly integrated in the mobile device. Communication technologies that can provide such ability include Ultra-Wide Band (UWB) and Bluetooth Low Energy® BLE time-of-flight (ToF) and/or BLE Phasing.

BLE ToF and BLE Phasing can be used separately for localization. Phasing flips (crosses zero phase periodically) approximately every 150 m, which may be problematic for long range distance measurement applications but zero crossing is not a concern for applications operating within 6 m of the vehicle.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 depicts a functional schematic of a Driver Assist Technologies (DAT) controller in accordance with the present disclosure.

FIG. 3 depicts a flow diagram of an example parking maneuver using a tethered ReDAT system in accordance with the present disclosure.

FIG. 4 illustrates an example user interface of a Remote Driver Assist Technologies (REDAT) application used to control a vehicle parking maneuver in accordance with the present disclosure.

FIG. 5 illustrates an example user interface of the ReDAT application used to control the vehicle parking maneuver in accordance with the present disclosure.

FIG. 6 illustrates an example user interface of the ReDAT application used to control the vehicle parking maneuver in accordance with the present disclosure.

FIG. 7 illustrates an example user interface of the ReDAT application used to control the vehicle parking maneuver in accordance with the present disclosure.

FIG. 8 illustrates an example user interface of the ReDAT application used to control the vehicle parking maneuver in accordance with the present disclosure.

FIG. 9 illustrates an example user interface of the ReDAT application used to control the vehicle parking maneuver in accordance with the present disclosure.

FIG. 10 illustrates an example user interface of the ReDAT application used to control the vehicle parking maneuver in accordance with the present disclosure.

FIG. 11 illustrates an example user interface of the ReDAT application used to control the vehicle parking maneuver in accordance with the present disclosure.

FIG. 12 illustrates an example user interface of the ReDAT application used to control the vehicle parking maneuver in accordance with the present disclosure.

FIG. 13 depicts a flow diagram of an example method for controlling the vehicle using a mobile device in accordance with the present disclosure.

### DETAILED DESCRIPTION

### Overview

The disclosure will be described more fully hereinafter with reference to the accompanying drawings, in which example embodiments of the disclosure are shown, and not intended to be limiting.

In view of safety goals, it is advantageous to verify that a user intends to remotely activate vehicle motion for a remote AV L2 feature, such as ReDAT. As a result, a user engagement signal is generated from the remote device (e.g., the mobile device operated by the user) and sent wirelessly to the vehicle. The sensor input provided by the user for the user engagement signal needs to be distinct from noise factors and failures of the device so that a noise factor or failure is not interpreted as user engagement by the system. The current solution generates a user engagement signal from an orbital motion traced by the User on the touchscreen, but many have found this task to be tedious. Additionally, some people do not recognize the orbital motion is being used as one possible method to assess user intent and view it as simply a poor Human-Machine Interface (HMI).

As an alternate approach to requiring a fob to be used in conjunction with the phone, Ford Motor Company® has developed a tether solution that allows the user to point the camera of their smartphone or other smart connected device at the vehicle to perform a vision tether operation. The vision tether system uses knowledge about the shape of the vehicle and key design points of the vehicle to calculate the distance from the phone. Such an approach can eliminate the need for the fob and also eliminates the need for the tedious orbital tracing on the smartphone since user intent is inferred from the action of the user pointing the smartphone camera at the vehicle.

This solution, although robust, may require a Computer Aided Design (CAD) model to be stored on the mobile device for each of the vehicles the mobile device is programmed to support. This solution may also require imbedding the associated vision software in a connected mobile device application such as the Fordpass® and MyLincolWay® applications. Moreover, users may not want to point the phone at the vehicle in the rain, or on very sunny days it may be hard to see the phone display from all vantage points.

Embodiments of the present disclosure describe an improved user interface that utilizes camera sensors on the mobile device, in conjunction with one or more other sensors, such as inertial sensors and the mobile device touchscreen, to acquire user inputs, generate a user engagement signal, and still utilize the localization technology (preferably UWB) onboard the mobile device to ensure the user (and more precisely, the mobile device operated by the user) are tethered to the vehicle within a predetermined distance threshold from the vehicle (e.g., within a 6 m tethering distance).

One or more embodiments of the present disclosure may reduce fatigue on the user's finger that previously had to continuously provide an orbital input on the screen to confirm intent and still use the wireless localization capability to minimize the complexity of the vision tether software and the complexity and size of the vehicle CAD models stored on the mobile device. Moreover, hardware limitations may be mitigated because a CAD model may not be required on the device, where the system may validate that the mobile device is pointed at the correct vehicle using light communication having a secured or distinctive pattern.

### Illustrative Embodiments

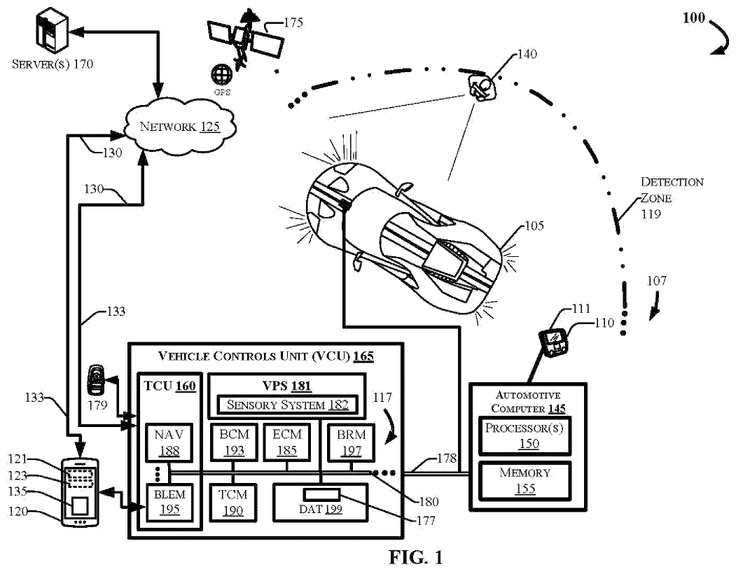

FIG. 1 depicts an example computing environment 100 that can include a vehicle 105. The vehicle 105 may include an automotive computer 145, and a Vehicle Controls Unit (VCU) 165 that can include a plurality of Electronic Control Units (ECUs) 117 disposed in communication with the automotive computer 145. A mobile device 120, which may be associated with a user 140 and the vehicle 105, may connect with the automotive computer 145 using wired and/or wireless communication protocols and transceivers. The mobile device 120 may be communicatively coupled with the vehicle 105 via one or more network(s) 125, which may communicate via one or more wireless connection(s) 130, and/or may connect with the vehicle 105 directly using Near Field Communication (NFC) protocols, Bluetooth® and Bluetooth Low Energy® protocols, Wi-Fi, Ultra-Wide Band (UWB), and other possible data connection and sharing techniques.

The vehicle 105 may also receive and/or be in communication with a Global Positioning System (GPS) 175. The GPS 175 may be a satellite system (as depicted in FIG. 1) such as the Global Navigation Satellite System (GNSS), Galileo, or navigation or other similar system. In other aspects, the GPS 175 may be a terrestrial-based navigation network. In some embodiments, the vehicle 105 may utilize a combination of GPS and Dead Reckoning responsive to determining that a threshold number of satellites are not recognized.

The automotive computer 145 may be or include an electronic vehicle controller, having one or more processor(s) 150 and memory 155. The automotive computer 145 may, in some example embodiments, be disposed in communication with the mobile device 120, and one or more server(s) 170. The server(s) 170 may be part of a cloud-based computing infrastructure, and may be associated with and/or include a Telematics Service Delivery Network (SDN) that provides digital data services to the vehicle 105 and other vehicles (not shown in FIG. 1) that may be part of a vehicle fleet.

Although illustrated as a sport vehicle, the vehicle 105 may take the form of another passenger or commercial automobile such as, for example, a car, a truck, a sport utility, a crossover vehicle, a van, a minivan, a taxi, a bus, etc., and may be configured and/or programmed to include various types of automotive drive systems. Example drive systems can include various types of Internal Combustion Engines (ICEs) powertrains having a gasoline, diesel, or natural gas-powered combustion engine with conventional drive components such as, a transmission, a drive shaft, a differential, etc. In another configuration, the vehicle 105 may be configured as an Electric Vehicle (EV). More particularly, the vehicle 105 may include a Battery EV (BEV) drive system, or be configured as a Hybrid EV (HEV) having an independent onboard powerplant, a Plug-in HEV (PHEV) that includes a HEV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a Fuel Cell Vehicle (FCV) that converts liquid or solid fuel to usable power using a fuel cell, (e.g., a Hydrogen Fuel Cell Vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4.

A vehicle having a Level-0 autonomous automation may not include autonomous driving features.

A vehicle having Level-1 autonomy may include a single automated driver assistance feature, such as steering or acceleration assistance. Adaptive cruise control is one such example of a Level-1 autonomous system that includes aspects of both acceleration and steering.

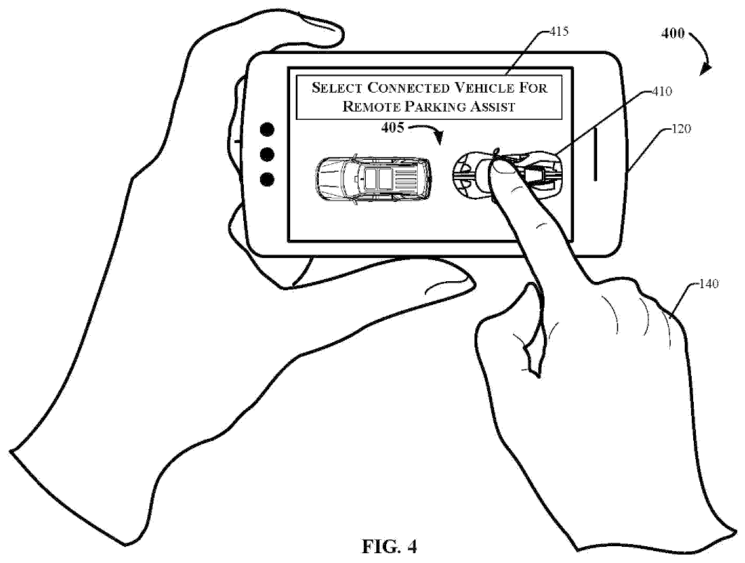

Level-2 autonomy in vehicles may provide driver assist technologies such as partial automation of steering and acceleration functionality and/or as Remote Driver Assist Technologies (ReDAT), where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation. For example, the supervisory aspects may be accomplished by a driver sitting behind the wheel of the vehicle, or as described in one or more embodiments of the present disclosure, the supervisory aspects may be performed by the user 140 operating the vehicle 105 using an interface of an application operating on a connected mobile device (e.g., the mobile device 120). Example interfaces are described in greater detail with respect to FIGS. 4-12.

Level-3 autonomy in a vehicle can provide conditional automation and control of driving features. For example, Level-3 vehicle autonomy may include “environmental detection” capabilities, where the Autonomous Vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system failure.

Level-5 AVs may include fully autonomous vehicle systems that require no human input for operation, and may not include human operational driving controls.

According to embodiments of the present disclosure, the remote driver assist technology (ReDAT) system 107 may be configured and/or programmed to operate with a vehicle having a Level-2 or Level-3 autonomous vehicle controller. Accordingly, the ReDAT system 107 may provide some aspects of human control to the vehicle 105, when the vehicle 105 is configured as an AV.

The mobile device 120 can include a memory 123 for storing program instructions associated with an application 135 that, when executed by a mobile device processor 121, performs aspects of the disclosed embodiments. The application (or “app”) 135 may be part of the ReDAT system 107, or may provide information to the ReDAT system 107 and/or receive information from the ReDAT system 107.

In some aspects, the mobile device 120 may communicate with the vehicle 105 through the one or more wireless connection(s) 130, which may or may not be encrypted and established between the mobile device 120 and a Telematics Control Unit (TCU) 160. The mobile device 120 may communicate with the TCU 160 using a wireless transmitter (not shown in FIG. 1) associated with the TCU 160 on the vehicle 105. The transmitter may communicate with the mobile device 120 using a wireless communication network such as, for example, the one or more network(s) 125. The wireless connection(s) 130 are depicted in FIG. 1 as communicating via the one or more network(s) 125, and via one or more wireless connection(s) 133 that can be direct connection(s) between the vehicle 105 and the mobile device 120. The wireless connection(s) 133 may include various low-energy protocols including, for example, Bluetooth®, Bluetooth® Low-Energy (BLE®), UWB, Near Field Communication (NFC), or other protocols.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication protocols such as, for example, Transmission Control Protocol/Internet Protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPA), Long-Term Evolution (LTE), Global System for Mobile Communications (GSM), and Fifth Generation (5G), to name a few examples. In other aspects, the communication protocols may include optical communication protocols featuring light communication observable by the human eye, using non-visible light (e.g., infrared), and/or a combination thereof.

The automotive computer 145 may be installed in an engine compartment of the vehicle 105 (or elsewhere in the vehicle 105) and operate as a functional part of the ReDAT system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases not shown in FIG. 1). The processor(s) 150 may utilize the memory 155 to store programs in code and/or to store data for performing aspects in accordance with the disclosure. The memory 155 may be a non-transitory computer-readable memory storing a ReDAT program code. The memory 155 can include any one or a combination of volatile memory elements (e.g., Dynamic Random Access Memory (DRAM), Synchronous Dynamic Random Access Memory (SDRAM), etc.) and can include any one or more nonvolatile memory elements (e.g., Erasable Programmable Read-Only Memory (EPROM), flash memory, Electrically Erasable Programmable Read-Only Memory (EEPROM), Programmable Read-Only Memory (PROM), etc.).

The VCU 165 may share a power bus 178 with the automotive computer 145, and may be configured and/or programmed to coordinate the data between vehicle 105 systems, connected servers (e.g., the server(s) 170), and other vehicles (not shown in FIG. 1) operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, a Driver Assistances Technologies (DAT) controller 199, etc. The VCU 165 may further include and/or communicate with a Vehicle Perception System (VPS) 181, having connectivity with and/or control of one or more vehicle sensory system(s) 182. In some aspects, the VCU 165 may control operational aspects of the vehicle 105, and implement one or more instruction sets received from the application 135 operating on the mobile device 120, from one or more instruction sets stored in computer memory 155 of the automotive computer 145, including instructions operational as part of the ReDAT system 107. Moreover, the application 135 may be and/or include a user interface operative with the ReDAT system 107 to perform one or more steps associated with aspects of the present disclosure.

The TCU 160 can be configured and/or programmed to provide vehicle connectivity to wireless computing systems onboard and offboard the vehicle 105, and may include a Navigation (NAV) receiver 188 for receiving and processing a GPS signal from the GPS 175, a BLE® Module (BLEM) 195, a Wi-Fi transceiver, a UWB transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and BLE® communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests, and connect directly with the mobile device 120, and/or one or more keys (which may include, for example, the fob 179).

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, the ReDAT system 107, and/or the server(s) 170, etc.), and may also communicate with one another without the necessity of a host computer.

The VCU 165 may control various loads directly via the bus 180 communication or implement such control in conjunction with the BCM 193. The ECUs 117 described with respect to the VCU 165 are provided for example purposes only, and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human drivers, inputs from an autonomous vehicle controller, the ReDAT system 107, and/or via wireless signal inputs received via the wireless connection(s) 133 from other connected devices such as the mobile device 120, among others. The ECUs 117, when configured as nodes in the bus 180, may each include a Central Processing Unit (CPU), a CAN controller, and/or a transceiver (not shown in FIG. 1). For example, although the mobile device 120 is depicted in FIG. 1 as connecting to the vehicle 105 via the BLEM 195, it is possible and contemplated that the wireless connection 133 may also or alternatively be established between the mobile device 120 and one or more of the ECUs 117 via the respective transceiver(s) associated with the module(s).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems, AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

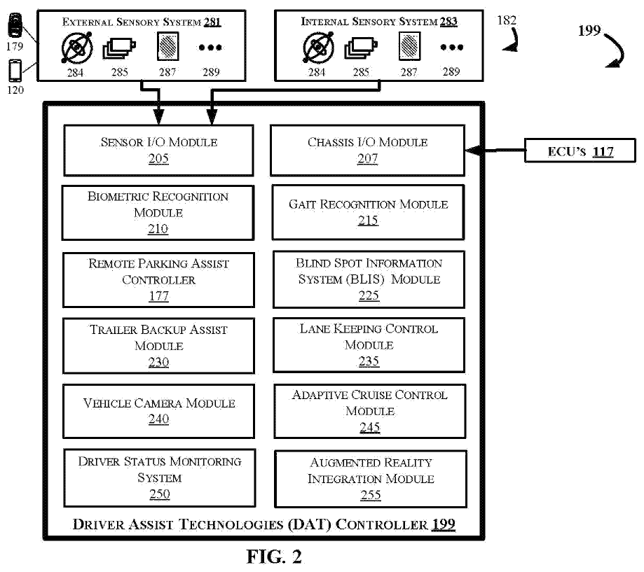

The DAT controller 199, described in greater detail with respect to FIG. 2, may provide Level-1, Level-2, or Level-3 automated driving and driver assistance functionality that can include, for example, active parking assistance that can include remote parking assist via a ReDAT controller 177, trailer backup assist module, a vehicle camera module adaptive cruise control, lane keeping, and/or driver status monitoring, among other features. The DAT controller 199 may also provide aspects of user and environmental inputs usable for user authentication. Authentication features may include, for example, biometric authentication and recognition.

The DAT controller 199 can obtain input information via the sensory system(s) 182, which may include sensors disposed on the vehicle interior and/or exterior (sensors not shown in FIG. 1). The DAT controller 199 may receive the sensor information associated with driver functions, vehicle functions, and environmental inputs, and other information, and utilize the sensor information to perform vehicle actions and communicate information for output to a connected user interface including operational options and control feedback, among other information.

In other aspects, the DAT controller 199 may also be configured and/or programmed to control Level-1 and/or Level-2 driver assistance when the vehicle 105 includes Level-1 or Level-2 autonomous vehicle driving features. The DAT controller 199 may connect with and/or include a Vehicle Perception System (VPS) 181, which may include internal and external sensory systems (collectively referred to as sensory systems 182). The sensory systems 182 may be configured and/or programmed to obtain sensor data usable for performing driver assistances operations such as, for example, active parking, trailer backup assistances, adaptive cruise control and lane keeping, driver status monitoring, and/or other features.

The computing system architecture of the automotive computer 145, VCU 165, and/or the ReDAT system 107 may omit certain computing modules. It should be readily understood that the computing environment depicted in FIG. 1 is an example of a possible implementation according to the present disclosure, and thus, it should not be considered limiting or exclusive.

The automotive computer 145 may connect with an infotainment system 110 that may provide an interface for the navigation and GPS receiver 188, and the ReDAT system 107. The infotainment system 110 may provide user identification using mobile device pairing techniques (e.g., connecting with the mobile device 120, a Personal Identification Number (PIN)) code, a password, passphrase, or other identifying means.

Now considering the DAT controller 199 in greater detail, FIG. 2 depicts an example DAT controller 199, in accordance with an embodiment. As explained in prior figures, the DAT controller 199 may provide automated driving and driver assistance functionality and may provide aspects of user and environmental assistance. The DAT controller 199 may facilitate user authentication, and may provide vehicle monitoring, and multimedia integration with driving assistances such as remote parking assist maneuvers.

In one example embodiment, the DAT controller 199 may include a sensor I/O module 205, a chassis I/O module 207, a Biometric Recognition Module (BRM) 210, a gait recognition module 215, the ReDAT controller 177, a Blind Spot Information System (BLIS) module 225, a trailer backup assist module 230, a lane keeping control module 235, a vehicle camera module 240, an adaptive cruise control module 245, a driver status monitoring system 250, and an augmented reality integration module 255, among other systems. It should be appreciated that the functional schematic depicted in FIG. 2 is provided as an overview of functional capabilities for the DAT controller 199. In some embodiments, the vehicle 105 may include more or fewer modules and control systems.

The DAT controller 199 can obtain input information via the sensory system(s) 182, which may include the external sensory system 281 and the internal sensory system 283 sensors disposed on the vehicle 105 interior and/or exterior, and via the chassis I/O module 207, which may be in communication with the ECUs 117. The DAT controller 199 may receive the sensor information associated with driver functions, and environmental inputs, and other information from the sensory system(s) 182. According to one or more embodiments, the external sensory system 281 may further include sensory system components disposed onboard the mobile device 120.

In other aspects, the DAT controller 199 may also be configured and/or programmed to control Level-1 and/or Level-2 driver assistance when the vehicle 105 includes Level-1 or Level-2 autonomous vehicle driving features. The DAT controller 199 may connect with and/or include the VPS 181, which may include internal and external sensory systems (collectively referred to as sensory systems 182). The sensory systems 182 may be configured and/or programmed to obtain sensor data for performing driver assistances operations such as, for example, active parking, trailer backup assistances, adaptive cruise control and lane keeping, driver status monitoring, remote parking assist, and/or other features.

The DAT controller 199 may further connect with the sensory system 182, which can include the internal sensory system 283, which may include any number of sensors configured in the vehicle interior (e.g., the vehicle cabin, which is not depicted in FIG. 2).

The external sensory system 281 and internal sensory system 283, which may include sensory devices integrated with the mobile device 120, and/or include sensory devices disposed onboard the vehicle 105, can connect with and/or include one or more Inertial Measurement Units (IMUs) 284, camera sensor(s) 285, fingerprint sensor(s) 287, and/or other sensor(s) 289, and may be used to obtain environmental data for providing driver assistances features. The DAT controller 199 may obtain, from the internal and external sensory systems 283 and 281, sensory data that can include external sensor response signal(s) 279 and internal sensor response signal(s) 275, via the sensor I/O module 205.

The internal and external sensory systems 283 and 281 may provide the sensory data obtained from the external sensory system 281 and the sensory data from the internal sensory system. The sensory data may include information from any of the sensors 284-289, where external sensor request messages and/or the internal sensor request messages can include the sensor modality with which the respective sensor system(s) are to obtain the sensory data. For example, such information may identify one or more IMUs 284 associated with the mobile device 120, with IMU sensor output, and determine that the user 140 should receive an output message to reposition the mobile device 120, or reposition him/herself with respect to the vehicle 105 during ReDAT maneuvers.

The camera sensor(s) 285 may include thermal cameras, optical cameras, and/or a hybrid camera having optical, thermal, or other sensing capabilities. Thermal cameras may provide thermal information of objects within a frame of view of the camera(s), including, for example, a heat map figure of a subject in the camera frame. An optical camera may provide a color and/or black-and-white image data of the target(s) within the camera frame. The camera sensor(s) 285 may further include static imaging, or provide a series of sampled data (e.g., a camera feed).

The IMU(s) 284 may include a gyroscope, an accelerometer, a magnetometer, or other inertial measurement device. The fingerprint sensor(s) 287 can include any number of sensor devices configured and/or programmed to obtain fingerprint information. The fingerprint sensor(s) 287 and/or the IMU(s) 284 may also be integrated with and/or communicate with a passive key device, such as, for example, the mobile device 120 and/or the fob 179. The fingerprint sensor(s) 287 and/or the IMU(s) 284 may also (or alternatively) be disposed on a vehicle exterior space such as the engine compartment (not shown in FIG. 2), door panel (not shown in FIG. 2), etc. In other aspects, when included with the internal sensory system 283, the IMU(s) 284 may be integrated in one or more modules disposed within the vehicle cabin or on another vehicle interior surface.

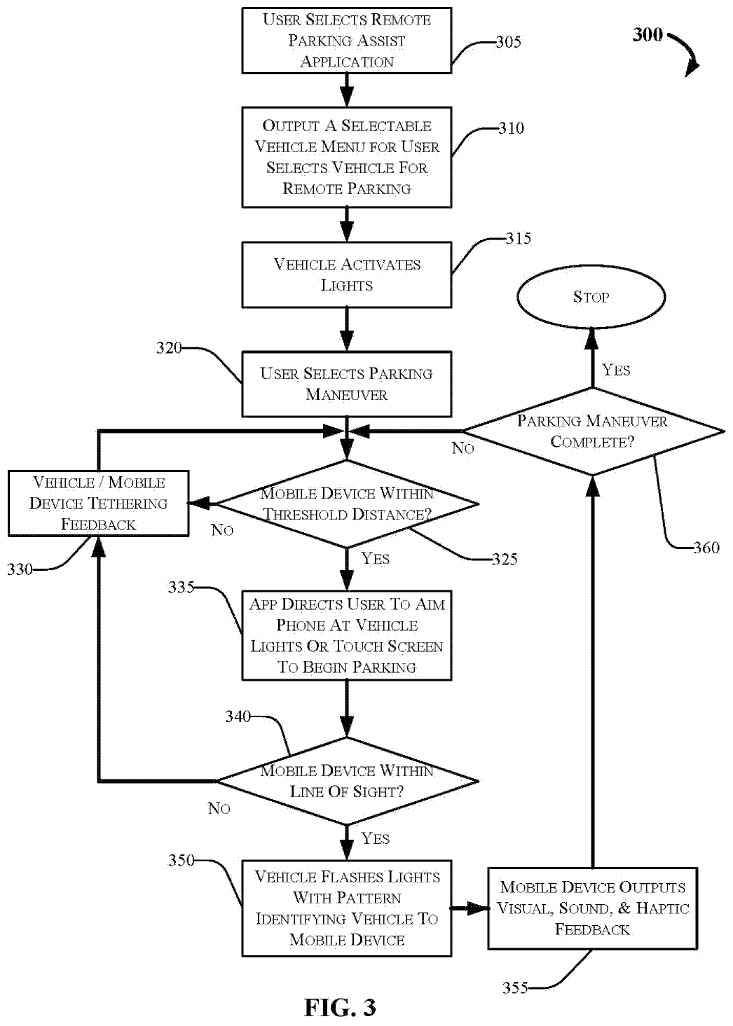

FIG. 3 depicts a flow diagram 300 of an example parking maneuver using the ReDAT system 107, in accordance with the present disclosure. FIGS. 4-12 illustrate aspects of steps discussed with respect to FIG. 3, including example user interfaces associated with the ReDAT system 107. Accordingly, reference to these figures are made in the following section. FIG. 3 may also be described with continued reference to prior figures, including FIGS. 1 and 2.

The following process is exemplary and not confined to the steps described hereafter. Moreover, alternative embodiments may include more or less steps that are shown or described herein, and may include these steps in a different order than the order described in the following example embodiments.

By way of an overview, the process may begin by selecting ReDAT in the ReDAT application 135 (which may be, for example, a FordPass® app installed on their mobile device 120). After instantiated responsive to launching (e.g., executing), the ReDAT application 135 may ask the user to select the vehicle if multiple vehicles associated with the app are within a valid range. Next, the vehicle will turn on its lights and the app will ask the user 140 to select a parking maneuver. Once the user selects the parking maneuver, the app will ask the user 140 to aim the mobile device 120 at one or more of the vehicle lights (e.g., a head lamp or tail lamp). The ReDAT application 135 may also ask the user 140 to touch a particular location or locations on the touchscreen to launch the ReDAT parking maneuver and commence vehicle motion. This step may ensure that the user is adequately engaged with the vehicle operation, and is not distracted from the task at hand. The vehicle 105 may flash the exterior lights with a pattern that identifies the vehicle to the phone, prior to engaging in the ReDAT parking maneuver, and during the ReDAT parking maneuver. The mobile device and the vehicle may output various outputs to signal tethered vehicle tracking during the maneuver.

Now considering these steps in greater detail, referring to FIG. 3, at step 305 the user 140 may select the ReDAT application 135 on the mobile device 120. This step may include receiving a selection/actuation of an icon and/or a verbal command to launch the ReDAT application 135.

At step 310, the ReDAT system 107 may output a selectable vehicle menu for user selection of the vehicle for a ReDAT maneuver. The ReDAT maneuver may be, for example, remote parking of the selected vehicle. FIG. 4 illustrates an example user interface 400 of the ReDAT application 135 used to control the vehicle 105 parking maneuver, in accordance with the present disclosure.

As shown in FIG. 4, the user 140 is illustrated as selecting icon 410, that represents the vehicle 105 with which the user 140 may intend to establish a tethered ReDAT connection and perform the remote parking maneuver. With reference to FIG. 4, after launching the ReDAT application 135 on the mobile device 120, the ReDAT application 135 may present images or icons 405 associated with one or more of a plurality of vehicles (e.g., one of which being the vehicle 105 as shown in FIG. 1) that may be associated with the ReDAT system 107. The vehicles may be associated with the ReDAT application 135 based on prior connection and/or control using the application. In other aspects, they may be associated with the ReDAT application 135 using an interface (not shown) for vehicle setup.

The mobile device 120 and/or the vehicle 105 may determine that the mobile device 120 is within the detection zone 119 (as shown in FIG. 1), which may localize the vehicles 105 within a threshold distance from the mobile device 120. Example threshold distances may be, for example, 6 m, 5 m, 7 m, etc.

Responsive to determining that the mobile device 120 is in the detection zone from at least one associated vehicle, the mobile device 120 interface may further output the one or more icons 405 for user selection, and output an audible and/or visual instruction 415, such as, for example, “Select Connected Vehicle For Remote Parking Assist.” The selectable icons 405 may be presented according to an indication that the respective vehicles are within the detection zone. For example, if the user 140 is in a lot having two associated vehicles within the detection zone, the ReDAT application 135 may present both vehicles that are within range for user selection.

With reference again to FIG. 3, at step 315, the ReDAT system 107 may cause the vehicle 105 to activate the vehicle lights (e.g., head lamps, tail lamps, etc.). This may signal connectivity to the user 140. In another embodiment, the signal may be an audible noise (e.g., sounding the vehicle horn), haptic feedback via the mobile device 120, or another alert mechanism.

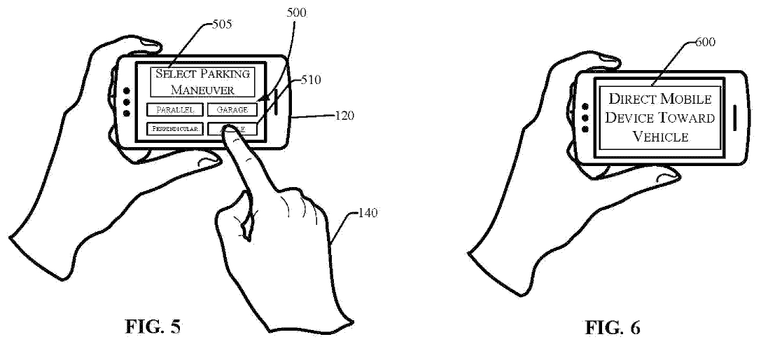

At step 320, the ReDAT system 107 present a plurality of user selectable remote parking assist maneuvers from which the user may select. FIG. 5 illustrates an example user interface of the ReDAT application 135 used to control the vehicle parking maneuver, in accordance with the present disclosure. The mobile device 120 is illustrated in FIG. 5 presenting a plurality of icons 500, and an instruction message 505 that may include, for example, “Select Parking Maneuver,” or a similar message. Example maneuvers can include but are not limited to operations such as, for example, parallel parking, garage parking, perpendicular parking, angle parking, etc. FIG. 5 depicts the user 140 selecting an icon 510 for angle parking responsive to the instruction message 505.

Referring again to FIG. 3, the user selects the parking maneuver at step 320. The ReDAT system 107 may determine, at step 325, whether the mobile device 120 is positioned within the allowable threshold distance from the vehicle 105 (e.g., whether the mobile device 120 and the user 140 are within the detection zone 119 illustrated in FIG. 1).

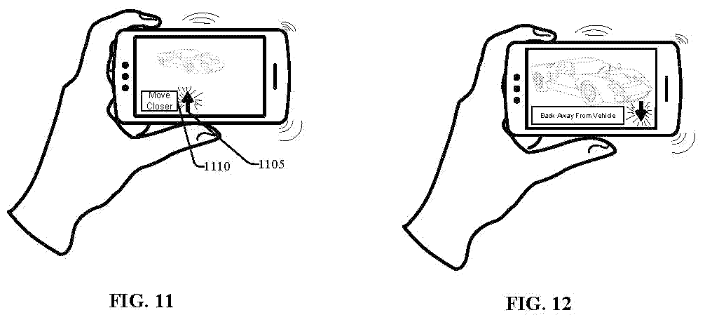

For the tethering function, the user may carry the fob 179 or use improved localization technologies available from the mobile device such as UWB and BLE® time-of-flight (ToF) and/or Phasing. The mobile device 120 may generate an output that warns the user 140 if they are currently localized (or if moving) approaching the tethering distance limit of the mobile device 120 (e.g., approaching the extent of the detection zone 119), or if the tethering distance is exceeded and the mobile device 120 is not localized within the threshold distance (e.g., the user 140 is outside of the detection zone 119), the ReDAT system 107 may coach the user 140 to move closer to the vehicle 105. An example coaching output is depicted in FIG. 11.

With reference given to FIG. 11, the ReDAT system 107 may cause the mobile device 120 to output a color icon 1105 (e.g., a yellow arrow) on the user interface of the mobile device 120, where the arrow is presented in a perspective view that points toward the vehicle 105 when approaching the tethering limit. The ReDAT system 107 may also output a visual, verbal, haptic, or other warning when approaching the tethering limit. For example, the mobile device 120 is illustrated as outputting the message “Move Closer.” Other messages are possible and such messages are contemplated herein.

When the tethering limit is exceeded, the ReDAT system 107 may generate a command to the VCU 165 that causes the vehicle 105 to stop. In one example embodiment, the ReDAT system 107 may cause the mobile device 120 to output one or more blinking red arrows in the perspective view (e.g., the message 1110 may indicate a message such as “Maneuver Has Stopped.” According to another embodiment, the ReDAT system 107 may issue a haptic feedback command causing the mobile device 120 to vibrate. Other feedback options may include an audible verbal instruction, a chirp or other warning sound, and/or the like.

Tethering feedback may further include one or more location adjustment messages that include other directions for moving toward the vehicle 105, away from the vehicle 105, or an instruction for bringing the vehicle and/or vehicle lights into the field of view of the mobile device cameras, such as, “Direct Mobile Device Toward Vehicle,” if the mobile device does not have the vehicle and/or vehicle lights in the frame of view. Other example messages may include, “Move To The Left,” “Move To The Right,” etc. In other aspects, the ReDAT system 107 may determine that other possible sources of user disengagement may be present, such as an active voice call, an active video call/chat, or instantiation of a chat client. In such examples, the ReDAT system 107 may output an instruction such as, for example, “Please Close Chat Application to Proceed,” or other similar instructive messages.

The vehicle 105 may also provide feedback to the user 140 by flashing the lights, activating the horn, and/or activating another audible or viewable warning medium in a pattern associated with the tethering and tracking state of the mobile device 120. Additionally, the ReDAT system 107 may reduce the vehicle 105 speed responsive to determining that the user 140 is approaching the tethering limit (e.g., the predetermined threshold for distance).

With attention given again to FIG. 3, responsive to determining that the user 140 is not within the threshold distance (e.g., the tethering limit) at step 325, the ReDAT system 107 may cause to output vehicle outputs and/or tethering feedback via the mobile device 120, as shown at step 330.

At step 335 the ReDAT system 107 may direct the user 140 to aim the mobile device 120 at the vehicle lights (e.g., the head lamps or tail lamps of the vehicle 105), or touch the screen to begin parking. For example, the ReDAT system 107 may determine whether the field of view of the mobile device cameras includes enough of the vehicle periphery and/or adequate field of view that includes an area of vehicle light(s) visible in the frame.

In one aspect, the application may instruct the mobile device processor to determine whether the total area of the vehicle lights is less than a second predetermined threshold (e.g., expressed as a percentage of pixels visible in the view frame verses the pixels determined to be associated with the vehicle lights when they are completely in view of the view frame, etc.).

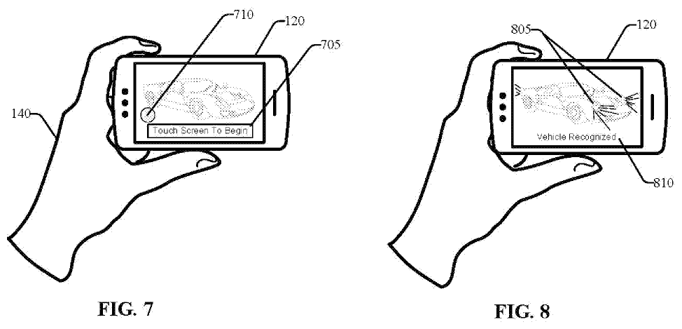

As another example, the ReDAT system 107 may determine user engagement using an interactive screen touch feature that causes the user 140 to interact with the interface of the mobile device 120. Accordingly, the mobile device 120 may output an instruction 705 to touch a portion of the user interface, as illustrated in FIG. 7. With reference to FIG. 7, the mobile device 120 is illustrated outputting the user instruction 705, which indicates “Touch Screen To Begin.” Accordingly, the ReDAT application 135 may choose a screen portion 710, and output an icon or circle indicating that to be a portion of the interface at which the user is to provide input. In another embodiment, the ReDAT system 107 may change the screen portion 710 to a second location on the user interface of the mobile device 120, where the second location is different from a prior location for requesting user feedback by touching the screen. This may mitigate the possibility of the user 140 habitually touching the same spot on the mobile device 120, and thus, prevent the user's muscle memory from always touching the same screen portion out of habit instead of authentic engagement. Accordingly, the ReDAT system 107 may determine that the user is engaged with the parking maneuver and is not distracted at step 335 using screen touch or using field of view checking.

The ReDAT system 107 may not only provide tethering feedback via the mobile device 120 as described with respect to FIG. 7, the ReDAT system 107 may further provide vehicle-generated feedback, as illustrated in FIG. 8. For example, the ReDAT system may provide a visual cue from the vehicle 105, such as flashing the vehicle headlamps 805, and/or provide messages 810 indicative that the vehicle is recognized and ready to commence the ReDAT maneuver.

At step 340, the ReDAT system 107 may determine whether the mobile device 120 has direct line of sight with the vehicle 105. Responsive to determining that the vehicle does not have direct line of sight with the mobile device 120, the ReDAT system 107 may output a message to move closer at step 330. FIG. 11 depicts an example user interface displaying such a message. The mobile device 120 may use its inertial sensors (e.g., one or more of the external sensory system 281) to detect if the user 140 is holding the mobile device 120 at an appropriate angle for the camera sensor(s) 285 to detect the vehicle lights and provide the appropriate feedback to the user 140. The ReDAT system 107 may also compare sensory outputs such as a magnetometer signal associated with the external sensory system 281 to a vehicle magnetometer signal associated with the internal sensory system 283, to determine a relative angle between the mobile device 120 and the vehicle 105. This may aid the mobile device 120 to determine which vehicle lights are in the field of view of the mobile device 120, which may be used to generate instructive messages for the user 140, including a direction or orientation in which the mobile device 120 should be oriented with respect to the vehicle 105.

FIG. 9 depicts an example of the ReDAT system 107 displaying an output message 905 (at step 330 of FIG. 3) indicative of a determination that the vehicle 105 is not in the line of sight of the mobile device 120. The ReDAT system 107 may cause the mobile device 120 to output the output message 905 having instructions to bring the vehicle into the field of view of the mobile device 120 by, for example, tilting the mobile device up, down, left, right, etc. In another aspect, with continued reference to FIG. 9, the ReDAT system 107 may output an instructive graphic, such as an arrow 910 or a series of arrows (not shown in FIG. 9), an animation (not shown in FIG. 9), an audible instruction, or another communication.

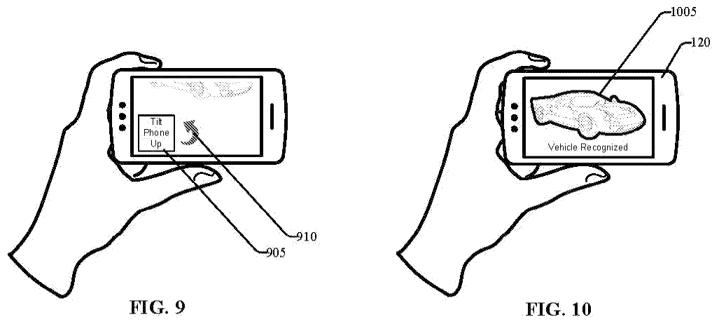

Responsive to determining that the mobile device 120 is not within the line of sight of the vehicle 105, at step 330, the ReDAT system 107 may output one or more signals via the vehicle 105 and/or the mobile device 120. For example, at step 330 and depicted in FIG. 10, the ReDAT system 107 may output an overlay 1005 on the mobile device 120 showing the status of the vehicle light tracking.

In one aspect, a colored outline surrounding the output image of the vehicle 105 may alert a connection status between the mobile device 120 and the vehicle 105. For example, a green outline output on the user interface of the mobile device 120 may be overlaid at a periphery of the vehicle head lamp, tail lamp, or the entire vehicle (as shown in FIG. 10, where the outline 1005 surrounds the entire vehicle image on mobile device 120), as an augmented reality output. This system output can indicate the mobile device 120 is successfully tracking the vehicle 105 and/or the vehicle's lights, or not tracking the vehicle 105 and/or the vehicle lights. A first color outline (e.g., a yellow outline) may indicate that the vehicle's light is too close to the edge of the image frame or the area of the light detected is below a threshold. In this case, the vehicle light(s) used for tracking make blink in a particular pattern and a visual and/or audible cue may be provided to indicate to the user which way to pan or tilt the phone, as illustrated in FIG. 9.

In other aspects, referring again to FIG. 3, at step 350, the ReDAT system 107 may cause the vehicle 105 to flash lights with a pattern identifying the vehicle 105 to the mobile device 120. This may include a pattern of flashes with timing and frequency that may be recognizable by the mobile device 120. For example, the mobile device memory 123 (as shown in FIG. 1) may store an encoded pattern and frequency of light flashes that uniquely identifies the vehicle 105 to the ReDAT application 135. Accordingly, the ReDAT application 135 may cause mobile device processor 121 to receive the light input using one or more of the external sensory system 281 devices, reference the memory location storing the light pattern identification, match the observed light frequency and pattern to a stored vehicle record (vehicle record not shown in FIG. 3), and determine that the vehicle 105 observed within a field of view of the mobile device 120, and the vehicle is flashing its lights in a pattern and/or frequency associated with the stored vehicle record.

Responsive to matching the vehicle with the stored vehicle record, and as illustrated in FIG. 8, the mobile device 120 may output an indication of a successfully-identified vehicle/mobile device match. For example, a message 810 may indicate that the vehicle 105 is in the field of view of the mobile device 120, and the vehicle 105 is actuating its headlamps 805 as an acknowledgement of successful connection and/or as a signal of recognition of the mobile device.

At step 355, the ReDAT system 107 may cause the mobile device 120 to output visual, sound, and/or haptic feedback. As before, the ReDAT application 135 may assist the user 140 to troubleshoot the problem to activate the feature by providing visual and audible cues to bring vehicle light(s) into view. For example, and as illustrated in FIG. 11, the ReDAT system 107 may include haptic feedback as output indicative of connection status between the mobile device 120 and the vehicle 105. If the mobile device 120 is unable to track the vehicle lights, the vehicle 105 may cease the remote parking assist maneuver, and cause the mobile device to vibrate and display a message such as “Vehicle stopped, can't track lights.” In another example, and as illustrated in FIG. 11, the ReDAT system 107 may cause the mobile device 120 to output a message such as “Move Closer”, thus alerting the user 140 to proceed to a location proximate to the vehicle 105 (e.g., as illustrated in FIG. 11), to proceed to a location further away from the vehicle 105 (e.g., as illustrated in FIG. 12), or to re-orient the position of the mobile device 120 (e.g., as illustrated in FIG. 9). In one embodiment, the ReDAT system 107 may also output illustrative instructions such as an arrow, graphic, animation, audible instruction.

At step 360, the ReDAT system 107 may determine whether the parking maneuver is complete, and iteratively repeat steps 325-355 until successful completion of the maneuver.

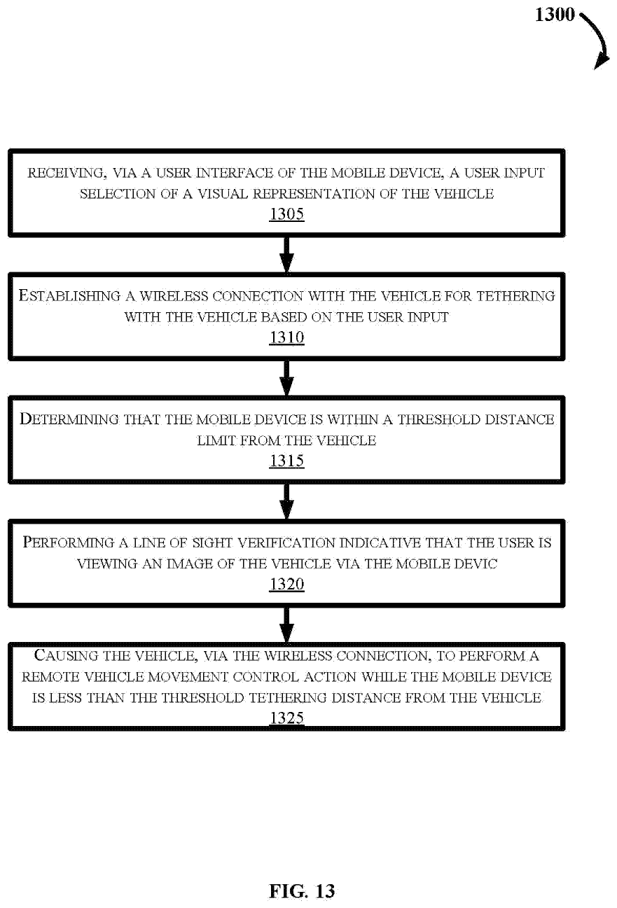

FIG. 13 is a flow diagram of an example method 1300 for remote wireless vehicle tethering, according to the present disclosure. FIG. 13 may be described with continued reference to prior figures, including FIGS. 1-12. The following process is exemplary and not confined to the steps described hereafter. Moreover, alternative embodiments may include more or less steps that are shown or described herein, and may include these steps in a different order than the order described in the following example embodiments.

Referring to FIG. 13, at step 1305, the method 1300 may commence with receiving, via a user interface of the mobile device, a user input selection of a visual representation of the vehicle. This step may include receiving a user input or selection of an icon that launches the application for ReDAT maneuver control using the mobile device.

At step 1310, the method 1300 may further include establishing a wireless connection with the vehicle for tethering with the vehicle based on the user input. This step may include causing the mobile device to cause vehicle and mobile device communication for user localization. In one aspect, the localization signal is Ultra-Wide Band (UWB) signal. In another aspect, the localization signal is a Bluetooth Low Energy (BLE) signal. The packet may include instructions for causing the vehicle to trigger a light communication output using vehicle head lamps, tail lamps, or another light source. In one aspect, the light communication may include an encoded pattern, frequency, and/or light intensity that may be decoded by the mobile device 120 to uniquely identify the vehicle, transmit an instruction or command, and/or perform other aspects of vehicle-to-mobile device communication.

At step 1315, the method 1300 may further include determining that the mobile device is within a threshold distance limit from the vehicle. This step may include the UWB distance determination and/or localization, BLE localization, Wi-fi localization, and/or another method.

At step 1320, the method 1300 may further include performing a line of sight verification indicative that the user is viewing an image of the vehicle via the mobile device. The line of sight verification can include determining whether vehicle headlamps, tail lamps, or other portions of the vehicle are in a field of view of the mobile device camera(s). This step may further include generating, via the mobile device, an instruction to aim a mobile device camera at an active light on the vehicle, and receiving, via the mobile device camera, an encoded message via the active light on the vehicle.

The step may include determining a user engagement metric based on the encoded message. The user engagement metric may be, for example, a quantitative value indicative of an amount of engagement (e.g., user attention to the remote parking or other vehicle maneuver at hand). For example, when the user is engaged with the maneuver, the user may perform tasks requested by the application that can include touching the interface at a particular point, responding to system queries and requests for user input, performing actions such as repositioning the mobile device, repositioning the view frame of the mobile device sensory system, confirming audible and/or visual indicators of vehicle-mobile device communication, and other indicators as described herein. The system may determine user engagement by comparing reaction times to a predetermined threshold for maximum response time (e.g., 1 second, 3 seconds, 5 seconds, etc.). In one example embodiment, the system may assign a lower value to the user engagement metric responsive to determining that the user has exceeded the threshold maximum value for user engagement, missed a target response area of the user interface when the user is asked by the application to touch a screen portion, failed to move in a direction requested by the application, moved too slowly with respect to a time that a request was made, etc.

The encoded message may be transmitted via a photonic messaging protocol using the active light on the vehicle and/or received by the vehicle via one or more transceivers. While the user engagement exceeds a threshold value, the parking maneuver proceeds. Alternatively, responsive to determining that the user engagement does not exceed the threshold value, the system may cease the parking maneuver and/or output user engagement alerts, warnings, instructions, etc.

At step 1325, the method 1300 may further include causing the vehicle, via the wireless connection, to perform a ReDAT action while the mobile device is less than the threshold tethering distance from the vehicle. This step may include receiving, via the mobile device, an input indicative of a parking maneuver, and causing the vehicle to perform the parking maneuver responsive to the input indicative of the parking maneuver.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more Application Specific Integrated Circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for controlling a vehicle using a mobile device, comprising:
receiving, via a user interface of the mobile device, a user input of a visual representation of the vehicle;
establishing a wireless connection with the vehicle for tethering with the vehicle based on the user input;
determining that the mobile device is within a threshold distance limit from the vehicle;
performing a line of sight verification indicative that a user is viewing an image of the vehicle via the mobile device; and
causing the vehicle, via the wireless connection, to perform a remote vehicle movement control action while the mobile device is less than the threshold distance limit from the vehicle.

2. The method according to claim 1, wherein performing the line of sight verification comprises causing vehicle and mobile device communication for user localization.

3. The method according to claim 2, wherein performing the line of sight verification further comprises:
causing to send, via the wireless connection, a visual communication request packet to the vehicle, the visual communication packet comprising instructions for causing the vehicle to trigger a light communication output; and
receiving a light indicator signal indicative that the mobile device is within a threshold tethering distance from the vehicle.

4. The method according to claim 2, wherein the user localization is based on an Ultra-Wide Band (UWB) signal.

5. The method according to claim 2, wherein the user localization is based on a Bluetooth Low Energy (BLE) signal.

6. The method according to claim 1, wherein causing the vehicle to perform the remote vehicle movement control action comprises:
receiving, via the mobile device, an input indicative of a parking maneuver; and
causing the vehicle to perform the parking maneuver responsive to the input indicative of the parking maneuver.

7. The method according to claim 6, further comprising:
generating, via the mobile device, an instruction to aim a mobile device camera at an active light on the vehicle;
receiving, via the mobile device camera, an encoded message via the active light on the vehicle;
determining a user engagement metric based on the encoded message; and
causing the vehicle to perform the parking maneuver responsive to determining that the user engagement metric indicates user attention to the remote vehicle movement control action.

8. The method according to claim 7, wherein the encoded message is transmitted via a photonic messaging protocol using the active light on the vehicle.

9. The method according to claim 7, further comprising:
determining that the mobile device camera does not have clear line of sight with the vehicle; and
outputting a message indicative of repositioning the mobile device to achieve a line of sight with the vehicle or to move to a location less than the threshold distance limit from the vehicle.

10. The method according to claim 7, further comprising:
generating, via the mobile device, a visual indication showing a status of a tracking condition while the vehicle performs the remote vehicle movement control action.

11. The method according to claim 10, wherein the visual indication comprises:
an image of the vehicle; and
an illuminated outline of the vehicle having a color indicative of the remote vehicle movement control action tracking condition.

12. The method according to claim 11, further comprising:
receiving from an active light on the vehicle, a blinking light indicator that signals a diminished user engagement; and
causing cessation of the parking maneuver responsive to determining that the user engagement metric does not indicate user attention to the remote vehicle movement control action.

13. A mobile device system, comprising:
a processor; and
a memory for storing executable instructions, the processor programmed to execute the instructions to:
receive, via a user interface of a mobile device, a user input of a visual representation of a vehicle;
establish a wireless connection with the vehicle for tethering with the vehicle based on the user input;
determine that the mobile device is within a threshold distance limit from the vehicle;
perform a line of sight verification indicative that a user is viewing an image of the vehicle via the mobile device; and
cause the vehicle, via the wireless connection, to perform a remote vehicle movement control action while the mobile device is less than the threshold distance limit from the vehicle.

14. The system according to claim 13, wherein the processor is further programmed to perform the line of sight verification by executing the instructions to:
transmit a localization signal to the vehicle.

15. The system according to claim 14, wherein the processor is further programmed to perform the line of sight verification by executing the instructions to:
cause to send, via the wireless connection, a visual communication request packet to the vehicle, the visual communication packet comprising instructions for causing the vehicle to trigger a light communication output; and
receive a light indicator signal indicative that the mobile device is within a threshold tethering distance from the vehicle.

16. The system according to claim 14, wherein localization is based on an Ultra-Wide Band (UWB) signal.

17. The system according to claim 14, wherein localization is based on a Bluetooth Low Energy (BLE) signal.

18. The system according to claim 13, wherein the processor is programmed to cause the vehicle to perform the remote vehicle movement control action by executing the instructions to:
receive, via the mobile device, an input indicative of a parking maneuver; and
cause the vehicle to perform the parking maneuver responsive to the input indicative of the parking maneuver.

19. The system according to claim 18, wherein the processor is further programmed to cause the vehicle to perform the remote vehicle movement control action by executing the instructions to:
generate, via the mobile device, an instruction to aim a mobile device camera at an active light on the vehicle;
receive, via the mobile device camera, an encoded message via the active light on the vehicle;
determine a user engagement metric based on the encoded message; and
cause the vehicle to perform the parking maneuver responsive to determining that the user engagement metric indicates user attention to the remote vehicle movement control action.

20. A method for controlling a vehicle using a mobile device, comprising:
establishing a wireless connection with the mobile device for tethering with the vehicle, the wireless connection responsive to a user input to the mobile device;
determining that the mobile device is within a threshold distance limit from the vehicle;
performing a line of sight verification indicative that a user is viewing an image of the vehicle via the mobile device; and
causing the vehicle, via the wireless connection, to perform a remote vehicle movement control action while the mobile device is less than the threshold distance limit from the vehicle.
